(19) United States
(12) Patent Application Publication
(10) Pub. No.: US 2026/0270106 A1
(43) Pub. Date: Sep. 10, 2026

(54) LIN COMMANDER RECESSIVE STATE LEVEL DETECTION

(71) Applicant: Infineon Technologies AG, Neubiberg (DE)

(72) Inventors: Martin Kilian, Unterhaching (DE); Magnus-Maria Hell, München (DE); Tobias Otter, Unterhaching (DE)

(21) Appl. No.: 19/533,971

(22) Filed: Feb. 9, 2026

(30) Foreign Application Priority Data
Mar. 10, 2025 (DE) 102025109014.9

(51) Int. Cl. H04L 12/40

(52) U.S. Cl. CPC H04L 12/40; H04L 2012/40234; H04L 2012/40273

(57) ABSTRACT

A network node of a LIN bus system is described that comprises a supply terminal, a bus terminal, a controllable voltage source, a receiver circuit and a controller circuit. The controllable voltage source is coupled to the supply terminal and is configured to output a voltage signal. The receiver circuit includes a comparator that is configured to compare a data signal with a reference signal. The comparator generates a binary output signal representing the result of the comparison, wherein the reference signal is based on the voltage signal. The controller circuit comprises a register that is configured to store at least one digital value, and a digital-to-analog converter, DAC. The DAC is coupled to the register and configured to output a voltage level based on the stored digital value. The controller circuit is coupled to the voltage source and configured to adjust the voltage signal based on the voltage level.

### TECHNICAL FIELD

This application relates to the field of Local Interconnect Network, LIN, bus communications, in particular to a LIN bus system having two network nodes with different supply voltages.

### BACKGROUND

Local Interconnect Network (LIN) is a serial network protocol designed for communication between different electronic modules and devices and mainly employed in the automotive fields for communication between Electrical Control Units (ECUs). LIN buses are a low-cost alternative to CAN buses and are known to be particularly robust and reliable.

As an industry standard, the LIN specification was developed by the LIN Consortium until 2010. It includes the physical layer, the bus protocol (layers 2-4 according to the OSI model), the interface to the application, and a uniform format for describing an entire LIN. The latest revision 2.2A of the specification was transferred to ISO and published as ISO standard 17987-1 (Road vehicles - Local interconnect network (LIN) - Part 1-8.

A LIN bus system includes one master device (bus master) and a plurality of slave devices (bus slaves). Conventionally, the master device and the slave devices share a common voltage domain that is used as a reference for the receivers of the network nodes. The supply voltages for a LIN node is typically 12 volts.

However, there is a trend for modern automotive boardnets having higher nominal voltages, such as 24 or 48 volts. There can thus arise situations in which the network nodes of the LIN system have different supply voltages. This can lead to losses of communication as it is no longer possible to clearly identify the recessive and the dominant states of the LIN data signal.

Accordingly, a need for an improved network node of a LIN bus system has been identified that makes it possible to communicate via a LIN bus data line with nodes having a different voltage supply.

### SUMMARY

The above-mentioned objective is achieved by the network node of claim 1, in particular by using a controller circuit that is able to adjust a voltage signal of a voltage source of the network node during a recessive state of the data signal, as well as by the method of claim 17.

In one example, the disclosure is directed to a network node of a LIN bus system comprising a supply terminal configured to receive a supply voltage, a bus terminal, a controllable voltage source, a receiver circuit and a controller circuit. The bus terminal is configured to receive a data signal representing serial data via a data line. The data signal is a binary signal having high and low signal levels. The controllable voltage source is coupled to the supply terminal and is configured to output a voltage signal. The receiver circuit includes a comparator that is configured to compare the data signal with a reference signal. The comparator generates a binary output signal representing the result of the comparison, wherein the reference signal is based on the voltage signal. The controller circuit comprises a register that is configured to store at least one digital value, and a digital-to-analog converter, DAC. The DAC is coupled to the register and configured to output a voltage level based on the stored digital value. The controller circuit is coupled to the voltage source and configured to adjust the voltage signal based on the voltage level.

In another example, the disclosure is directed to a method comprising the step of receiving, at a Local Interconnect Network, LIN, bus terminal of a network node of a LIN bus system. The data signal represents serial data via a data line and is a binary signal having high and low signal levels. The method further comprises the step of storing at least one digital value in a register of the network node. The method also comprises the step of outputting, by a digital-to-analog converter, DAC, a voltage level based on the stored digital value. In addition, the method comprises the step of adjusting a voltage signal output by a voltage source coupled to a supply terminal of the network node based on the voltage level. The method also comprises the step of comparing the data signal with a reference signal to generate a binary output signal representing the result of the comparison. The reference signal is based on the voltage signal.

### BRIEF DESCRIPTION OF THE DRAWINGS

The embodiments described herein can be better understood with reference to the following description and drawings. The components in the figures are not necessarily to scale, emphasis instead being placed upon illustrating the principles of the embodiments. Furthermore, in the figures, like reference numerals designate corresponding parts. In the drawings:

FIG. 1 illustrates a Local Interconnect Network (LIN) bus system with one commander node and (at least) two responder nodes.

FIG. 2 illustrates the structure of a frame according to the LIN specification rev. 2.2A. The frame is composed of a header and a response.

FIG. 3 illustrates the structure of a generic Byte field of a LIN frame.

FIG. 4 illustrates the structure of a Break field of a LIN frame (diagram (a)) and a Sync Byte Field (diagram (b)).

FIG. 5 illustrates an example of a LIN network including a LIN master node and a LIN slave node.

FIG. 6 illustrates examples of timing diagrams of the data signal and of the comparator output signal of the LIN slave node of FIG. 5.

FIG. 7 illustrates a first example of a LIN network including a LIN master node and a LIN slave node having a controller circuit, in accordance with one or more techniques described herein.

FIG. 8 illustrates an example of a controller circuit for the LIN slave node of FIG. 7, in accordance with one or more techniques described herein.

FIG. 9 illustrates a second example of a LIN network including a LIN master node and a LIN slave node having a controller circuit, in accordance with one or more techniques described herein.

FIG. 10 illustrates a first example of a controller circuit for the LIN slave node of FIG. 9, in accordance with one or more techniques described herein.

FIG. 11 illustrates a second example of a controller circuit for the LIN slave node of FIG. 9, in accordance with one or more techniques described herein.

FIG. 12 illustrates a second example of a controller circuit for the LIN slave node of FIG. 9, in accordance with one or more techniques described herein.

FIG. 13 is a flowchart illustrating a first example method for operating a network node of a LIN bus system, in accordance with one or more techniques described in this disclosure.

### DETAILED DESCRIPTION

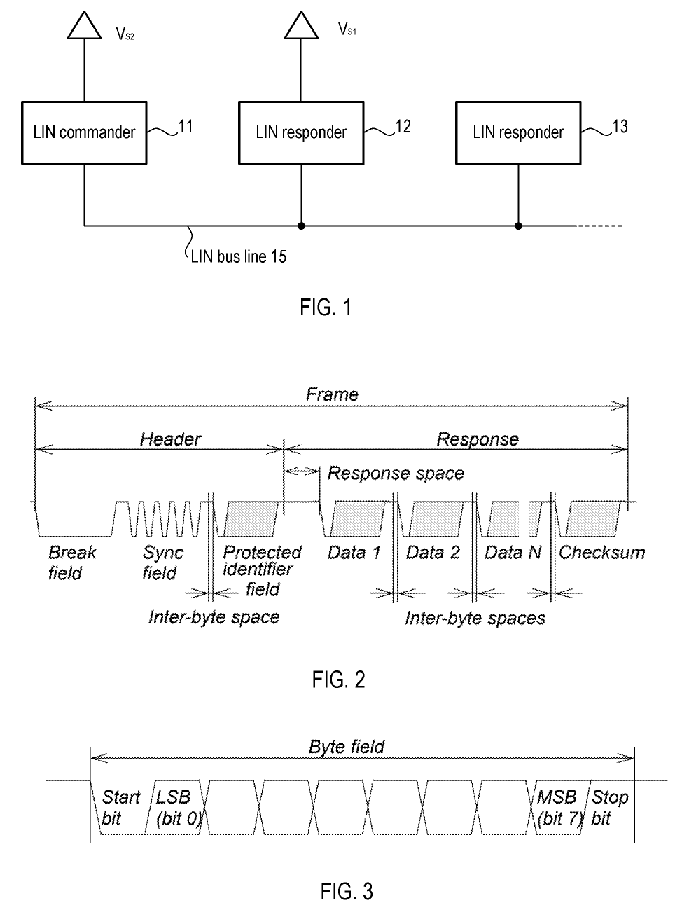

FIG. 1 illustrates a Local Interconnect Network, LIN, which may also be referred to as LIN bus system. The network includes one commander node 11 and one or more responder nodes, in the depicted example responder node 12 and responder node 13. All network nodes are connected via a bus line 15. The commander node 11 is configured to execute the commander task and may, in addition thereto, also be configured to execute a responder task (like the responder nodes) and thus also operate as a responder. The basic structure of a LIN bus system and the required functions of commander and responder network nodes are as such known from the LIN specification and thus not further discussed herein.

The LIN commander node 11 may include a communication interface, which allows communication with other entities or subsystems. In one example, the commander node 11 includes an interface to communicate with a Control Area Network, CAN, via CAN bus lines. Additionally or alternatively, the commander node may include (or be coupled with) any other source of data.

In one example, the nodes 11, 12 and 13 are electronic devices or electronic modules of a vehicle, commonly referred to as electronic control units ECUs.

In the depicted example, the commander node 11 is provided with a supply voltage V_{S2} and the responder node 12 is provided with a supply voltage V_{S1}. Conventionally, the supply voltage V_{S2} of the commander node 11 and the supply voltage V_{S1} of the responder node 12 are identical. The commander node 11 and the responder node 12 may be coupled to the same supply line. When they share a common voltage domain, they can communicate over a single wire. The voltage domain is used as a reference for the receivers of the nodes 11 and 12 in order to detect high and low levels of the LIN bus data signal.

However, the commander node 11 and the responder node 12 may also be connected to different boardnets having different voltage domains, for example because they have different nominal voltages. In this case, it is no longer possible to precisely determine the high and low levels of the LIN bus data signal, thereby leading to losses of communication, as will be explained below.

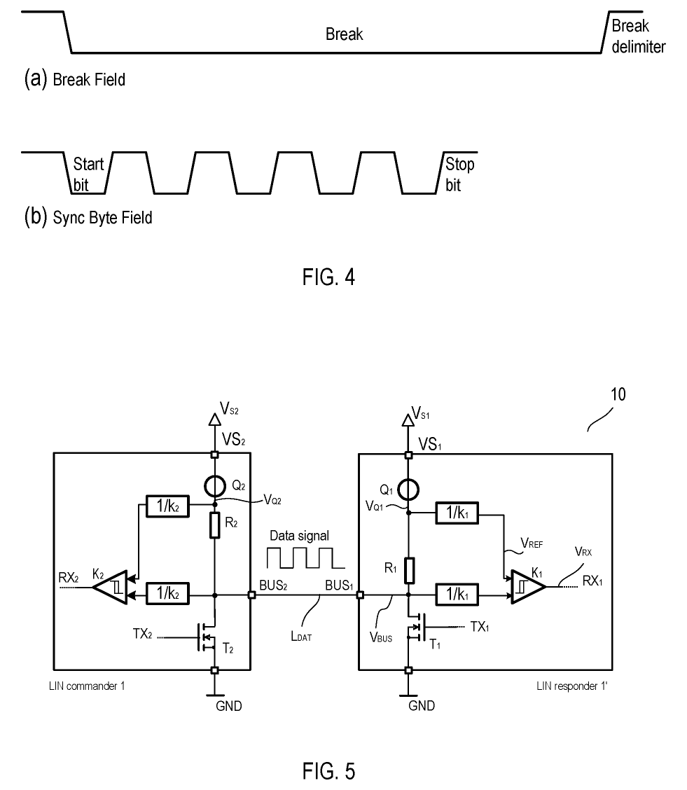

FIG. 2 illustrates the structure of a LIN frame in accordance with the LIN specification rev. 2.2A. Accordingly, a frame is composed of two parts, a header part and a response part. For each frame, the header is generated by the commander node 11, whereas the response may be generated by the commander node 11 or a responder node 12, 13. The header is composed of a Break field (see diagram (a) of FIG. 4), a Sync field (see diagram (b) of FIG. 4), and a Protected Identifier, PID, field.

The header starts at a falling edge of the break field and ends after the end of the stop bit of the PID field. The response is composed of one or more data fields and a special data field including a check sum (checksum field). The response starts at the end of stop bit of the PID field and ends at the after the stop bit of the checksum field.

The inter-byte space is the time between the end of the stop bit of the preceding field and the start bit of the following byte. The response space is the inter-byte space between the PID field and the first data field of the response.

FIG. 3 illustrates the structure of a generic Byte field of a LIN frame. Sync field, PID field, data fields and checksum field all have the structure of a Byte field. That is, each field starts with a (dominant) start bit, followed by eight bits (bits 0-7), and ends with a (recessive) stop bit. A dominant bit has a low level (bit with value zero) and a recessive bit has a high level (bit with value one). Accordingly, the length of a Byte field corresponds to the length of ten bits.

FIG. 4 shows two special fields, namely the Break field in diagram (a) and the Sync field (also referred to as Sync Byte field) in diagram (b). The break field is used to signal the beginning of a new frame. It is always generated by the commander node, and it is the only field that does not comply with the field structure shown in FIG. 3. As can be seen in FIG. 4, the Break field is longer than a normal Byte field. According to the specification, it is at least 13 nominal bit times long (with value zero) followed by a Break delimiter, which is at least one nominal bit time long (with value one). In other words, the Break field includes at least 13 dominant bits and the Break delimiter includes at least one recessive bit.

The Break field is followed by the Synch field. The Sync field is a normal Byte field having the value 85 (decimal) or 0b01010101 (binary). The most significant bit is bit 7.

The PID field consists of two sub-fields, namely the frame identifier and the parity bits. Bits 0 to 5 are the frame identifier (possible values from 0-63) and bits 6 and 7 are the parity bits.

A frame carries between one and eight bytes of data. The last field of a frame is the checksum field. The checksum field contains the inverted eight bit sum with carry over all data bytes or all data bytes and the protected identifier. The checksum can be calculated over the data bytes only (classic checksum) or over the data bytes and the protected identifier byte (enhanced checksum).

FIG. 5 illustrates an example of a LIN network system 10 having a LIN commander 1 (master node) and a LIN responder 1’ (slave node) which are interconnected via a LIN bus data line L_{DAT} to exchange serial data in a LIN standard-compliant manner. Only the relevant elements of the LIN network system are illustrated in FIG. 5. In particular, the LIN nodes may include a microcontroller to allow the software implementation of the functionality necessary for the LIN nodes.

Regardless of the actual purpose of a LIN node, a LIN node will always include a LIN transceiver which may be a separate integrated circuit or included in a microcontroller. Depending on the application, the LIN transceiver may also be formed on a printed circuit board using discrete circuit components. The illustrated components essentially correspond to the LIN transceiver parts of the LIN network nodes.

The LIN responder 1’ and the LIN commander 1 have a similar structure. In the following, the structure of the LIN responder 1’ will be explained in details. These explanations apply accordingly to the LIN commander 1.

The LIN responder 1’ comprises a supply terminal VS₁, a ground terminal GND, a receive terminal RX₁, a transmit terminal TX₁, and a LIN bus terminal BUS₁. The ground terminal GND generally relates to a reference potential, such as the body of a car.

The bus terminal BUS₁ is coupled to a LIN data line L_{DAT} for receiving a data signal V_{BUS} representing serial data from the LIN master node 1. The LIN bus line L_{DAT} is also connected to a bus terminal BUS₂ of the LIN commander 1. The serial data can be communicated bi-directionally between the LIN commander 1 and the LIN responder 1’ across the bus line L_{DAT} in accordance with the LIN specification. Accordingly, the data signal V_{BUS} is a binary signal having high and low signal levels. The low signal level equals approximately ground potential, e.g. 0 V, and the high signal level equals a LIN standard-compliant voltage V_{Q2} generated in the master node 1.

The supply terminal VS₁ is configured to receive a supply voltage V_{S1}. The supply voltage V_{S1} may be provided by a battery, such as an automotive battery, which typically provides a voltage between 13.8 and 14.4 volts. The LIN responder 1’ comprises a voltage source Q₁ that is coupled to the supply terminal VS₁ and is configured to output a voltage signal V_{Q1}. The voltage source Q₁ is configured to transform the supply voltage V_{S1} into a LIN-compliant voltage. In one example, the voltage source Q₁ is selected from the following list: a charge pump; a voltage regulator; and a voltage divider. In one example, the slave node 1’ is connected to the master node 1 via a supply line (not shown) and the slave node 1’ is provided with the voltage signal V_{Q2} of the master node 1.

The receive terminal RX₁ and the transmit terminal TX₁ of the LIN responder 1’ may be connected to respective terminals of a microcontroller (not illustrated). Serial data received from the LIN data line L_{DAT} may be forwarded to the microcontroller via the receive terminal RX₁ whereas the microcontroller is configured to provide serial data, which is to be sent across the LIN data line L_{DAT}, at the transmit terminal TX₁. Alternatively, the slave LIN node 1’ may operate without a dedicated microcontroller and may include some sensor circuitry instead.

The LIN responder 1’ includes a receiver circuit and a transmitter circuit, which together form an interface circuit between the receive output and the transmit input terminals RX₁, TX₁ and the LIN bus terminal BUS₁.

The receiver circuit includes a comparator K₁ that is configured to compare the data signal V_{BUS} with a reference signal V_{REF}. The comparator K₁ generates a binary output signal V_{RX} representing the result of the comparison. The reference signal V_{REF} is based on the voltage signal V_{Q1}. In the depicted example, the reference voltage V_{REF} is proportional to the voltage signal V_{Q1}. The voltage signal V_{Q1} is scaled down by a factor k₁ by a first scaling circuit. The factor k₁ is usually equal to two. In one example, the scaling circuit is a voltage divider. In another example, the reference voltage V_{REF} is set to a predetermined value. In one example, if the slave node 1’ and the master node 1 are connected via the supply line, the reference voltage V_{REF} may be determined based on the voltage signal V_{Q2} of the master node 1.

In the depicted example, the comparator K₁ is a comparator with hysteresis. A first input of the comparator K₁ is connected to the LIN bus terminal BUS₁, while a second input of the comparator K₁ is supplied with the reference voltage V_{REF}. A second scaling circuit is arranged between the LIN bus terminal BUS₁ and the first input of the comparator K₁, and is configured to scale down the data signal V_{BUS} by the factor k₁.

The output of the comparator K₁ is connected to the receive terminal RX₁. The comparator K₁ sets the voltage at the receive terminal RX₁ to a high level when the voltage level at the LIN bus terminal BUS₁ exceeds a first threshold defined by V_{REF}+V_{H}, and sets the voltage at the receive terminal RX₁ to a low level when the voltage level at the LIN bus terminal BUS₁ falls below a second threshold defined by V_{REF}-V_{H}, wherein the voltage V_{H} represents the mentioned hysteresis of the comparator. The hysteresis voltage V_{H} may be small compared to the reference voltage V_{REF}. With the hysteresis, it is possible to avoid an undesired toggling when the voltage level at the LIN bus terminal BUS₁ is close to the reference voltage V_{REF}. The voltage levels provided by the comparator K may be in accordance with the requirements of the microcontroller or circuitry connected to the receive and transmit terminals of the LIN responder 1’. In one example, a circuit for adjusting the voltage level (not shown) is coupled between the receive terminal RX₁ of the LIN responder 1’ and the circuitry.

The slave node 1’ further includes a transmitter circuit. The transmitter circuit comprises a transistor T₁ that is coupled between the ground terminal GND and the LIN bus terminal BUS₁. In one example, the transistor T₁ is a MOSFET. In another example, the transistor T₁ is a bipolar junction transistor. In the depicted example, a pull-up resistor R₁ is connected between the LIN bus terminal BUS₁ and the output of voltage source Q₁, for example via a diode (not illustrated). The control electrode (e.g., gate electrode) of the transistor T₁ is coupled to the transmit terminal TX₁. Thus, the transistor T₁ is switched on when a high level is applied to the terminal TX₁, whereas the transistor T₁ is switched off when a low level is applied to the terminal TX₁. When the transistor T₁ is switched on, it pulls the potential of the LIN bus terminal BUS₁ down to (approximately) ground potential. When the transistor T₁ is switched off, the pull-up resistor R₁ pulls the potential of the LIN bus terminal BUS₁ up to (approximately) the voltage V_{Q1} of the voltage source Q₁.

The LIN commander 1 has the same structure as the LIN responder 1’. In particular, the LIN commander 1 comprises a supply terminal VS₂, a ground terminal GND, a receive terminal RX₂, a transmit terminal TX₂, and a LIN bus terminal BUS₂. The LIN bus line L_{DAT} is connected to the bus terminal BUS₂ of the LIN commander 1 for outputting the data signal V_{BUS}. The receive terminal RX₂ and the transmit terminal TX₂ of the LIN transceiver 20 are connected to respective terminals of a microcontroller (not illustrated).

The supply terminal VS₂ is configured to receive a supply voltage V_{S2}. The supply voltage V_{S2} may be provided by a battery. The supply voltage V_{S2} may be in the 12 V voltage domain. However, the supply voltage V_{S2} may also be in a higher voltage domain, e.g. the 24 V or the 48 V voltage domain.

The LIN commander 1 comprises a voltage source Q₂ that is coupled to the supply terminal VS₂ and is configured to output a voltage signal V_{Q2}. According to the LIN specification, the voltage level of the voltage signal V_{Q2} should be between 7 V and 16 V, ideally 12 V.

The LIN commander 1 includes a receiver circuit and a transmitter circuit, which have a structure that is similar to that of the receiver and transmitter circuits of the LIN responder 1’. In particular, the receiver circuit including a comparator K₂ that is configured to compare the data signal V_{BUS} with a reference signal. The comparator K₁ generates a binary output signal representing the result of the comparison. The reference signal for the comparator K₂ is based on the voltage signal V_{Q2}. The voltage signal V_{Q2} is scaled down by a factor k₂ by a first scaling circuit. The factor k₂ may be equal to two. The output of the comparator K₂ is connected to the receive terminal RX₂. The transmitter circuit of the LIN commander 1 comprises a transistor T₂ that is coupled between the ground terminal GND and the LIN bus terminal BUS₂. In the depicted example, a pull-up resistor R₂ is connected between the LIN bus terminal BUS₂ and the output of voltage source Q₂. The control electrode of the transistor T₂ is coupled to the transmit terminal TX₂.

Conventionally, the LIN commander 1 and the LIN responder 1’ share the same voltage domain, e.g. the 12 V voltage domain, which is directly compatible with the requirements for the LIN standard. The supply voltage V_{S1} of the LIN commander 1 and the supply voltage V_{S2} of the LIN responder 1’ are then equal. In the conventional case, the supply voltages of the network nodes are between 7 V and 18 V. In automotive applications, the supply voltage is provided by an automotive battery which provides typical a voltage between 13.8 and 14.4 volts.

However, modern automotive board nets may work at higher voltages, such as 24 V, 48 V, 400 V or 800 V. This can lead to problems for LIN communication interfaces, in which the high and low levels of the LIN data signal are derived from the 12 V voltage domain. In fact, if the supply voltages of the network nodes are not in the 12 V voltage domain, the voltage references of the LIN network nodes have to be internally regulated, which may lead to variations in the different voltage references of the different network nodes and, thus, to losses of communication. The same problem may arise when the network nodes are connected to different boardnets having different voltage domains, i.e. when the supply voltage of at least one network nodes is not in the 12 V voltage domain. In particular, the supply voltage of the commander node may be higher than the supply voltage of the slave node.

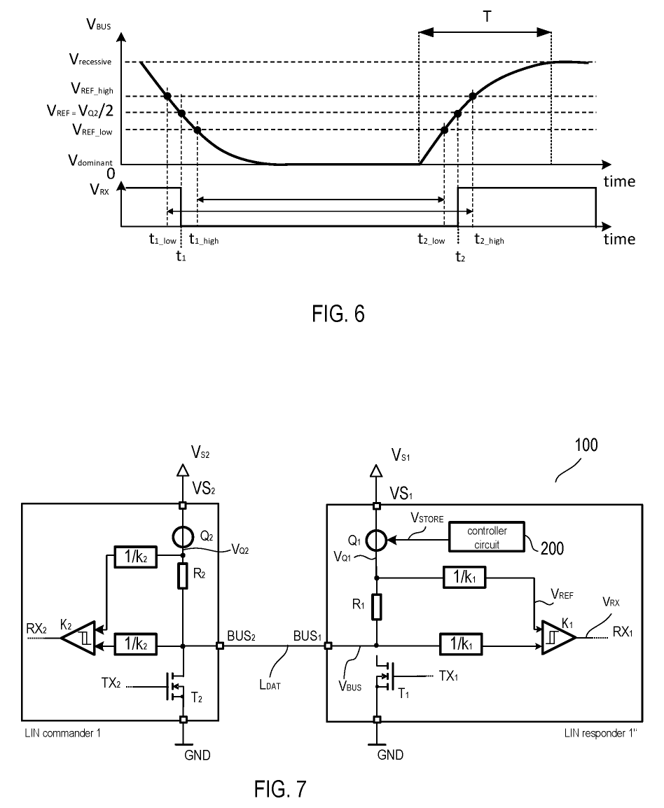

This problem is illustrated in FIG. 6, which shows timing diagrams of the data signal V_{BUS} (upper diagram) and of the binary output signal V_{RX} (lower diagram) of the LIN responder 1’ of FIG. 5. In the depicted example, the data signal V_{BUS} is a binary signal sent by the LIN commander 1 and has either a high voltage level V_{recessive} (recessive high level), which approximately corresponds to the voltage level of the voltage signal V_{Q2} output by the voltage source Q₂ of the LIN commander 1, or a low voltage level V_{dominant} (dominant low level), which basically corresponds to the ground voltage GND. In the depicted example, the low voltage level V_{dominant} is approximately equal to 0 V. Depending on the transmitter signal of the LIN commander 1, the LIN commander 1 pulls the LIN line to the dominant low level or to the recessive high level. However, the transition from one level to the other is not immediate and occurs over a transition period T.

In order to distinguish between the low dominant level and the high recessive level of the data signal V_{BUS} and, thus, obtain the binary receiver signal V_{RX} (comparator signal of the responder node 1’), the comparator K₁ of the LIN responder 1’ compares the data signal V_{BUS} to the reference voltage V_{REF}. When the data signal V_{BUS} exceeds the reference voltage V_{REF}, the comparator signal V_{RX} is changed from a first value that indicates a dominant state of the data signal to a second value that indicates a recessive state of the data signal. Ideally, the reference voltage V_{REF} of the LIN responder 1’ is equal to the reference voltage of the LIN commander 1, i.e. V_{Q2}/k₂.

If the LIN commander 1 and the LIN responder 1’ are both connected to the same board net, e.g. to a board net in the 12 V voltage domain, the voltage source Q₁ of the LIN responder 1’ may be chosen such that a voltage level of the voltage signal V_{Q1} be equal to the voltage level of the voltage signal V_{Q2} of the voltage source Q₂ of the LIN commander 1. Alternatively, the LIN responder 1’ may be connected to the LIN commander 1 via a supply line and directly receive the voltage signal V_{Q2} of the LIN commander 1. In both cases, the reference level V_{REF} may be set depending on the voltage level of the voltage signal V_{Q2}. In the depicted example, the reference level V_{REF} is set to half of the voltage level of the voltage source Q₂ of the LIN commander 1. This corresponds to the case when the scaling factor k₂ is equal to 2. This makes it possible to clearly distinguish the dominant state and the recessive state of the bus data signal. The receiver signal V_{RX} (comparator signal) is then set to the first value, e.g. “0”, at time t₁ and to the second value, e.g. “1”, at time t₂.

However, if the network nodes are connected to board nets having different voltage domains, the LIN responder 1’ will have to generate the reference voltage V_{REF} independently from the LIN commander 1. Because of differences in designs between the LIN commander 1 and the LIN responder 1’ or differences in the application of the network nodes 1 and 1’, the voltage reference V_{REF} of the LIN responder 1’, i.e. the voltage of the voltage source Q₁ scaled down by the scaling factor k₁, may not be equal to the reference voltage of the LIN commander, i.e. the voltage V_{Q2} scaled down by the scaling factor k₁, but may have a higher voltage level V_{REF_high} or a lower voltage level V_{REF_low}. The receiver signal V_{RX} will then be set to the first value slightly before time t₁, e.g. at time t_{1_low}, or slightly after time t₁, e.g. at time t_{1_high}. Similarly, the receiver signal V_{RX} will be set to the second value before time t₂, e.g. at time t_{2_low}, or after time t₂, e.g. at time t_{2_high}. Since the comparator signal V_{RX} may not correspond exactly to the data signal V_{BUS}, losses of communication between the LIN commander 1 and the LIN responder 1’ may occur.

FIG. 7 shows a further example of a LIN network including a LIN master node 1 and a LIN slave node 1’’. Compared with the LIN network of FIG. 5, the voltage source Q₁ of the LIN responder 1’’ is controllable. In addition, the LIN responder 1’’ further comprises a controller circuit 200 coupled to the voltage source Q₁ and configured to adjust the voltage signal V_{Q1} of the controllable voltage source Q₁ based on a voltage level V_{STORE}, thereby adjusting the reference signal V_{REF}. By adapting the voltage source Q₁, it is possible to adjust the reference voltage V_{REF} so that it is equal to reference voltage of the LIN commander 1. With this, the receiver signal at the receiver terminal RX₁ can follow more accurately the data signal V_{BUS}, thereby improving the communication between the network nodes 1 and 1’’, even when one of the network nodes uses a board net with a voltage domain that is different from the standard 12 V voltage domain.

In one example, the voltage source Q₁ is a charge pump. With this, the controller circuit 200 can control the charge pump Q1 to scale up or down the supply voltage VS1 to obtain the desired voltage level V_{STORE}. In particular, if the supply voltage V_{S1} of the LIN responder 1’’ is higher than supply voltage V_{S2} of the LIN commander 1, it will need to be scaled down. If the supply voltage V_{S1} of the LIN responder 1’’ is lower than supply voltage V_{S2} of the LIN commander 1, it will need to be scaled up. Using a charge pump makes it possible to easily adapt to each particular case.

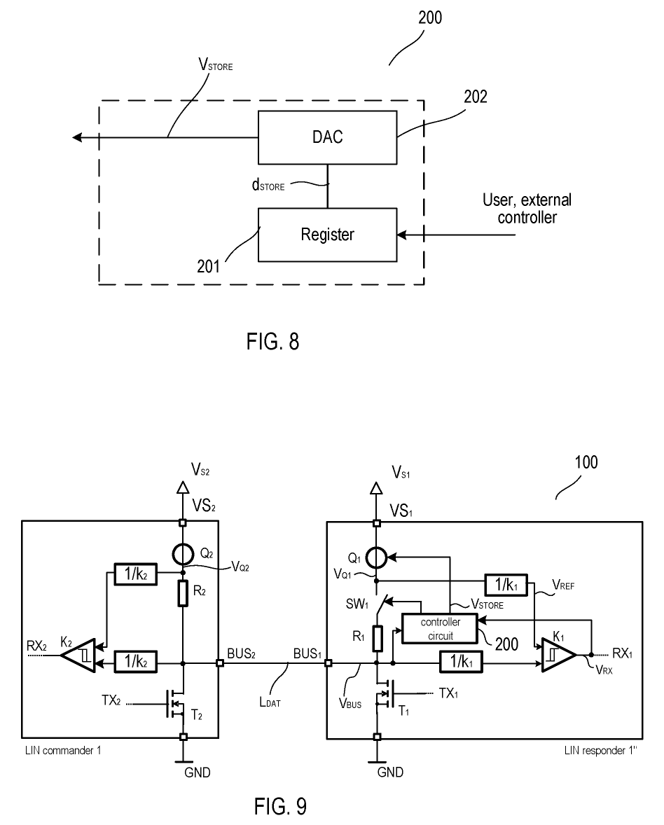

FIG. 8 illustrates an example of a controller circuit 200 which may be used in different implementations of a LIN slave node 1’’ as shown, e.g., in FIG. 7. In the depicted example, the controller circuit 200 comprises a register 201 that is configured to store at least one digital value d_{STORE}, and a digital-to-analog converter, DAC, 202 that is coupled to the register 201 and configured to output a voltage level V_{STORE} based on the stored digital value d_{STORE}. In one example, the register 201 is a shift register that is able to store a single digital word. In another example, the register 201 is able to store a plurality of digital words. In one example, the register 201 is configurable by one of: an external controller; and a user. In one example, an external controller configures the register 201 based on data input that provide information on the LIN commander, on the application of the LIN commander or on the board net connected to the LIN commander. The register 201 may be configured via a Serial Peripheral Interface, SPI. In another example, the user inputs the digital word via a CAN line. In one example, the stored digital value is fixed. The register 201 may be configured only once before a start of the ECUs. Alternatively, the register 201 may be dynamically configured during running of the ECUs. This open-loop implementation is particularly simple. In particular, the number of required components is kept to a minimum and there is no need to measure or analyze the data signal.

FIG. 9 shows another example of a LIN network including a LIN master node 1 and a LIN slave node 1’’. Compared with the LIN slave node 1’’ of FIG. 7, the controller circuit 200 of FIG. 9 is configured to receive the data signal V_{BUS} via the data line L_{DAT}, as well as the binary output signal V_{RX} of the comparator K₁. Further, the LIN responder 1’’ may comprise a switching element SW₁ connected in series with the pull-up resistor R1. The controller circuit 200 may be configured to switch on and off the switching element SW₁ and, thus, the pull-up resistor R₁. In one example, the controller circuit 200 is configured to switch off the pull-up resistor R₁ while adjusting the voltage signal V_{Q1} of the controllable voltage source Q₁. With this, it is possible to prevent that the potential of the LIN bus terminal BUS₁ be pulled to a voltage Q₁ that has not yet been adjusted, and to avoid interferences between the function of the controller circuit 200 and the data communication.

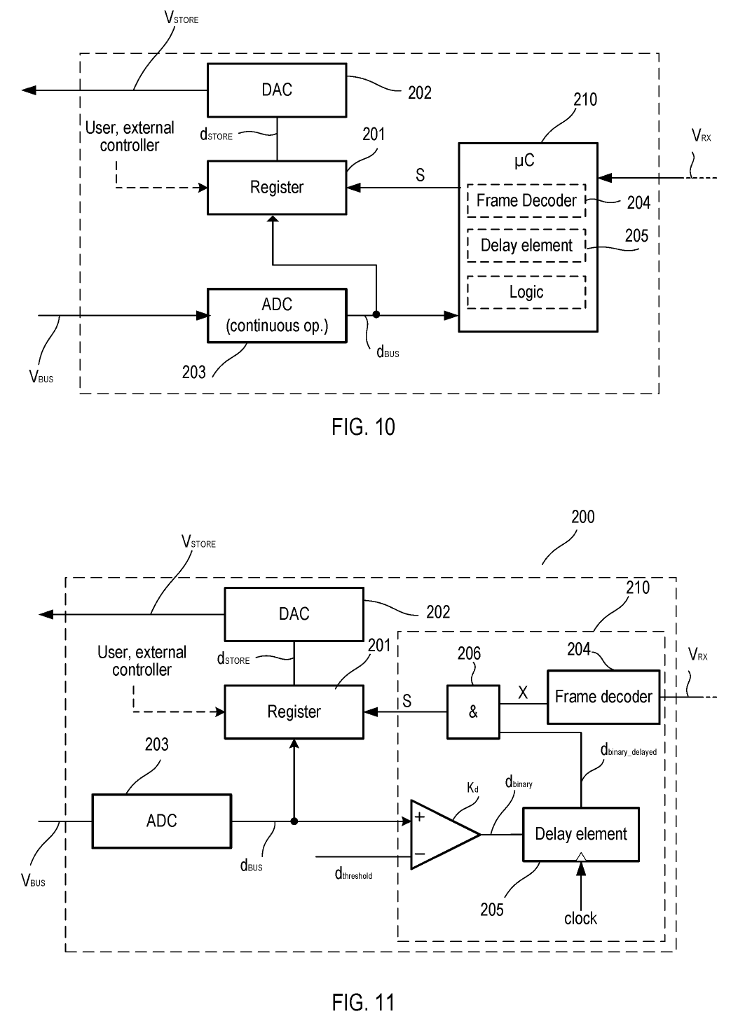

FIG. 10 illustrates another example of a controller circuit 200 which may be used in the LIN slave node 1’’ of FIG. 9. The controller circuit 200 is coupled to the bus terminal BUS₁ and further comprises an analog-to-digital converter, ADC, 203 configured to receive the data signal V_{BUS} and to generate a digitized data signal d_{BUS} based on the data signal V_{BUS}. The controller circuit 200 further comprises a register 201 that is coupled to the ADC 203. The register 201 is configured to receive the digitized data signal d_{BUS} from the ADC 203 and to store at least one value d_{STORE} of the digitized data signal d_{BUS} that represents a high signal level (recessive state) of the data signal V_{BUS}. The controller circuit 200 also comprises a digital-to-analog converter, DAC, 202 that is coupled to the register 201 and configured to output a voltage level V_{STORE} based on the stored digital value d_{STORE}. By sampling the data signal V_{BUS} directly from the data line L_{DAT}, the voltage signal V_{Q1} of the voltage source Q₁, and thus the reference voltage V_{REF}, can be adjusted based on the high signal level of the data signal V_{BUS}, which depends on the voltage signal V_{Q2} of the voltage source Q₂ of the LIN commander 1. In one example, the controller circuit 200 works as a sample-and-hold circuit, wherein the register 201 stores a value of the digitized data line signal d_{bus} at a first predetermined sampling time and holds this value until a further value of the digitized data line signal d_{bus} is stored at second predetermined sampling time. In one example, the ADC 203 is configured to continuously sample the data signal V_{BUS} at a predetermined frequency. The controller circuit 200 may be configured to generate a clock signal and the register 201 may be configured to store the value d_{STORE} of the digitized data signal d_{BUS} according to the clock signal. The clock signal may be synchronized with the frames of the data line signal V_{BUS}.

In the depicted example, the controller circuit 200 further comprises a detector circuit 210 that is coupled to the register 201. The detector circuit 210 is configured to receive the binary output signal V_{RX} and to output a trigger signal S based on the binary output signal V_{RX}. The trigger signal S is a binary signal that indicates whether a rising edge of the data signal V_{BUS} has been detected. The detector circuit 210 may be configured to output a first value of the trigger signal S, e.g. a high level value “1”, when a rising edge has been detected. The register 201 may be further configured to store the value d_{STORE} of the digitized data signal d_{BUS} based on the trigger signal S. In one example, the register 201 is further configured to store the value d_{STORE} of the digitized data signal d_{BUS} when the trigger signal S has the first value. The trigger signal S thus acts as a clock signal for the register 201. In one example, the stored current value d_{STORE} remains unchanged until a further rising edge of the data signal V_{BUS} has been detected. In one example, the detector circuit 210 comprises a logic circuit that is configured to detect rising edges of the data signal V_{BUS} based on the digitized data signal d_{BUS}. In another example, the detection of the rising edges is based directly on the binary output signal V_{RX} of the comparator K₁. By detecting rising edges of the data signal V_{BUS}, it is possible to determine sampling times for the register 201, so that the register 201 only samples the digitized data signal d_{BUS} during recessive states (high signal level) of the data signal V_{BUS}.

The detector circuit 210 may be partly software-implemented using an appropriate processor (e.g., a microcontroller). The processor may be configured to execute instructions of the software that are stored in a memory. In another example, the detector circuit 210 is fully hardware-implemented and does not need a programmable processor. The detector circuit 210 may also be implemented as a combination of hardware and software.

In one example, the register 201 comprises a plurality of single registers and is configured to store a plurality of values of the digitized data signal d_{BUS}. The register 201 may also be further configured to average the stored values and to output an average value to the DAC 202. With this, it is possible to prevent the voltage source from being adjusted based on outliers. Alternatively, the register 201 may be configured to recognize unreasonable values and to only store values that are conform to expected values.

In one example, the detector circuit 210 further comprises a frame decoder 204 configured to detect a first time window of the data signal V_{BUS}. In one example, the frame decoder 204 is configured to detect the time window based on at least one of: the digitized data signal d_{BUS} and the binary output signal V_{RX}. The time window contains at least one recessive bit that can be used for configuring the register 201. The detector circuit 210 is configured to output the trigger signal S further based on the detected first time window. The detector circuit 210 may receive the comparator output signal V_{RX} and detect the first time window based on the comparator output signal V_{RX}. In one example, the first time window is one of: a sync field of a current frame of the data signal V_{BUS}, a check sum field of the current frame of the data signal V_{BUS}, anda space between two consecutive frames of the data signal V_{BUS}. During these periods, the data line L_{DAT} does not send any useful data. The detector circuit 210 may be configured to only be able to output the first value of the trigger signal S during the first time window, i.e. when the bus is not busy, and to output a second value of the trigger signal S, e.g. a low level value “0”, the rest of the time. This makes it possible to prevent interferences with the active data fields.

For example, the break field of a frame includes at least 13 dominant bits that are followed by the break delimiter which includes at least one recessive bit. The frame decoder 204 may be configured to count the number of dominant bits of the data signal V_{BUS}, and, if this value exceeds a threshold, which may be set to 11, to determine that the actual field is a break field. The next detected recessive bit corresponds to the break delimiter, which is followed by the sync field. It is thus possible to detect the sync field by counting the number of dominant bits and detecting a rising edge after the number of dominant bits exceeds a predetermined threshold. Similarly, the frame decoder 204 may be configured to calculate the bits of the checksum field based on the values of the active bit fields of the current frame. The frame decoder 204 may then be configured to compare the number of expected rising edges to the number of detected rising edges of a field and, thus, detect the presence of the checksum field. The checksum field is followed by a space that comprises a large plurality of dominant bits and separates two frames. By detecting the checksum field and a following rising edge of the bus signal V_{BUS}, it is thus possible to also detect the space between two consecutive frames. Once the time window has been detected, the detector circuit 210 may be configured begin outputting the first value of the trigger signal S when a rising edge of the bus signal V_{BUS} has been detected.

In one example, the detector circuit 210 is configured to output the first value of the trigger signal S when a rising edge has been detected and the first time window has been detected. As mentioned above, a rising edge of the data signal V_{BUS} may be detected based on a at least one of: the digitized data signal d_{BUS} and the binary output signal V_{RX}. In one example, the detector circuit 210 is configured to output the first value of the trigger signal S each time a rising edge has been detected. When the first time window is the sync field, the detector circuit 210 may output the first value of the trigger signal S four times, namely each time one of the four rising edges of the sync field has been detected.

In a further example, the detector circuit 210 is configured to output the first value of the trigger signal S during starting up of the ECU. This makes it possible to configure the register 201 with an initial value and, thus, to simplify the adjustment of the level of the voltage source Q₁ afterwards.

In one example, the frame decoder 204 is further configured to detect an end of the first window of the data signal V_{BUS}. The register 201 is then configured to be locked after the detection of the end of the first window until the frame decoder 204 detects a further window of the data signal V_{BUS}. With this, after the end of the first window, the adaptation of the voltage signal V_{Q1} of the voltage source Q₁ can be stopped and the reference signal V_{REF} of the LIN responder 1’’ remains stable. In fact, it is not expected that the high signal level of the data line signal V_{BUS} changes during the transmission of the active bit fields. With this, unnecessary adjustments of the voltage signal V_{Q1} can be prevented.

In one example, the register 201 is configured to send to the DAC 202 only the last stored digital value d_{STORE} during the time window. This can reduce the number of communications within the LIN responder 1’’. In another example, the register 201 comprises a plurality of single registers, wherein each single register is configured to store a single digital value d_{STORE}. The register 201 may store a plurality of digital values d_{STORE} during the first window. The register 201 may be further configured to average the stored digital values d_{STORE} and to output an averaged digital value to the DAC 202. This can be helpful to exclude outlier values of the stored digital values d_{STORE}. The register 201 may be configured to output the averaged digital value to the DAC 202 after the end of the first window has been detected.

In one example, the detector circuit 210 further comprises a delay element 205 configured to delay the trigger signal S by a predetermined delay time t_{delay}. The delay element 205 may comprise a series of flip-flop elements. The delay element 205 may be placed at various positions in the detector circuit 210. In particular, the delay element 205 may be connected to an input or an output of the detector circuit 210. In one example, the detector circuit 210 comprises a plurality of delay elements. In one example, the register 201 is coupled to an output of the delay element 205 and is configured to store a current value d_{STORE} of the digitized data signal d_{BUS} based on the delayed trigger signal. Thus, register 201 does not sample and store the digitized data signal d_{BUS} immediately after a rising edge of the data line signal V_{BUS} has been detected 7, but after the predetermined delay time t_{delay}. With this, it is possible to make sure that the digitized data signal d_{BUS} is sampled when the high signal level has been reached, and not during a transition from the dominant to the recessive state. The reference signal V_{REF} can thus be adjusted based on the high signal level of the data line signal V_{BUS}, thereby increasing the accuracy of the receiver signal V_{RX}.

In one example, the predetermined delay time t_{delay} is configurable. The predetermined delay time t_{delay} may be configured by a user or by an external microcontroller. The predetermined delay time t_{delay} may be fixed before running up the ECUs. In another example, the predetermined delay time t_{delay} is dynamically adjusted. The predetermined delay time t_{delay} may be adjusted based on the data signal V_{BUS}. The detector circuit 210 may be configured to determine, for at least one of the detected rising edges, a period of time necessary to transition from a dominant to a recessive state and to adjust the predetermined delay time t_{delay} based on the determined period of time. The detector circuit 210 may be configured to determine the period of time for all detected rising edges of the data signal V_{BUS} during the first window. The detector circuit 210 may be configured to average the plurality of determined periods of time and to adjust the predetermined delay time t_{delay} based on the averaged period of time.

In one example, the controller circuit 200 is configured to switch on and off the pull-up resistor R₁ based on the trigger signal S. In particular, the controller circuit 200 may be configured to switch off the pull-up resistor R1 when the trigger signal S has the first value, i.e. when a recessive state has been detected during the first window and the register 201 stores a new digitized data voltage value d_{BUS}. With this, it is possible to prevent interferences between the data signal V_{BUS} and the function of the controller circuit 200. In one example, the controller circuit 200 is configured to switch off the pull-up resistor R₁ during the entirety of the time window.

The embodiment of FIG. 10 may also be combined with the embodiment of FIG. 8. In one example, the register 201 is also configurable, e.g. by an external controller or a user. The value d_{STORE} may be input via the external controller or the user as an initial value, e.g. before starting the ECUs. The further values d_{STORE} may be sampled from the digital bus signal d_{BUS} afterwards, e.g. during the function of the ECUs. In fact, the level of the supply voltage V_{S2} of the LIN commander 1 may be known and is not expected to change during function of the ECUs. By pre-configuring the value d_{STORE} stored in the register 201, the reference voltage V_{REF} of the LIN responder 1’’ can be set to a level that is near the reference voltage of the LIN commander 1. With this, it is possible to detect rising edges of the data signal V_{BUS} based on the binary output signal V_{RX} from the beginning. The value d_{STORE} stored in the register 201 can then be changed according to the detector circuit 210 to adjust to small changes of the high level value of the data signal V_{BUS}. This enables a very effective adjustment of the level of the voltage source Q₁ and of the reference voltage V_{REF} of the LIN responder 1’’.

FIG. 11 illustrates an example of the controller circuit 200 of FIG. 10, which may also be used in the LIN receiver node 1’’ of FIG. 9. In the example of FIG. 10, the detector circuit 210 comprises a digital comparator K_{d} that is configured to compare the digitized data signal d_{BUS} with a digital threshold value d_{threshold} to detect the rising edge of the data signal V_{BUS}. In particular, the digital comparator K_{d} may be configured to output a comparator output signal d_{binary} with a first value, e.g. a high value “1”, when the digitized data signal d_{BUS} exceeds the digital threshold value d_{threshold}. The digitized data signal d_{BUS} may be filtered before being input to the digital comparator K_{d}. The digital threshold value d_{threshold} may be configurable, e.g. by a user or an external controller. In one example, the digital threshold value d_{threshold} is configured based on the voltage domain of the LIN commander 1. In one example, the digital threshold value d_{threshold} is configured using a look-up table.

Further, in the depicted example, the controller circuit 200 comprises a delay element 205 that is coupled to the output of the digital comparator K_{d} and configured to delay the comparator output signal d_{binary} by the predetermined delay time t_{delay}. The predetermined delay time t_{delay} may be configurable. In one example, the delay element 205 receives as input a clock signal that can be configured by a user or an external controller. The predetermined delay time t_{delay} is configured to compensate for the transition time of the data signal V_{BUS} between the dominant and the recessive state to make sure that the register 201 will store a value of the digitized data signal d_{BUS} that corresponds to a high level value of the data signal V_{BUS}.

In the depicted example, the frame decoder 204 is configured to receive, as input, the comparator output signal V_{RX} and to output a binary signal X that indicates the presence or the absence of the first window based on the comparator output signal V_{RX}. The controller circuit 200 further comprises a logic circuit 206 that is configured to receive, as inputs, the delayed comparator output signal d_{binary_delayed} and the binary signal X of the frame decoder 204, and to output the binary trigger signal S. The binary trigger signal S thus has the first value only when the following two conditions are fulfilled: the delayed comparator output signal d_{binary_delayed} indicates a rising edge of the data signal V_{BUS}; and the binary signal X of the frame decoder 204 detects the first window. The register 210 is configured to receive the trigger signal S and to store the current digitized data signal value d_{STORE} when the trigger signal S has the first value.

The components of the controller circuit 200 may be arranged differently. In particular, the delay element 205 may be arranged in a different position, such as at the output of the controller circuit 210.

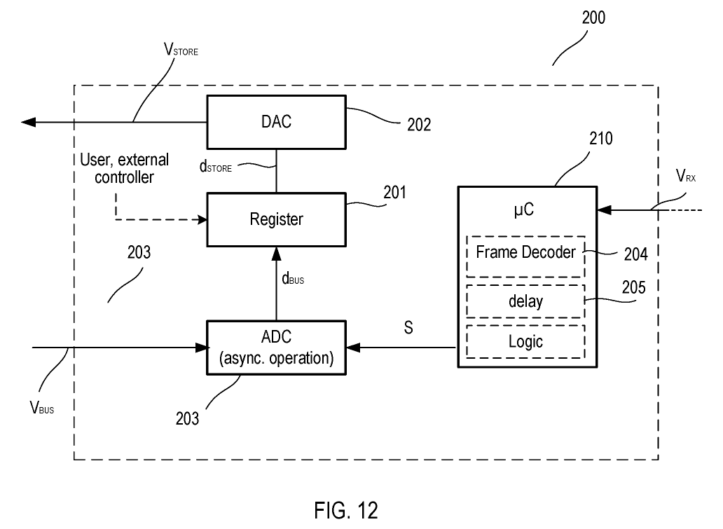

FIG. 12 illustrates a further example of a controller circuit 200 which may be used in the LIN slave node 1’’ of FIG. 9. Compared with the controller circuit of FIG. 10, the ADC 203 does not continuously sample the data signal V_{BUS}. Instead, the ADC 203 is configured to sample the data signal V_{BUS} based on the trigger signal S of the detector circuit 210. The detector circuit 210 uses the binary output signal V_{RX} of the comparator K₁ to detect rising edges of the data signal V_{BUS}. A rising edge is thus detected when the level of the scaled data signal V_{BUS} exceeds the reference voltage V_{REF}, taking into account the hysteresis of the comparator K₁. With this, the detector circuit 210 does not require any additional comparator to detect rising edges, such as the digital comparator K_{d} of FIG. 11. Further, the detector circuit 210 comprises a frame decoder 204 that is configured to determine a time window of the data signal V_{BUS} based on the binary output signal V_{RX}. The detector circuit 210 also comprises a logic circuit that is configured to output the binary trigger signal S with the first value when a rising edge is detected during the determined time window. The detector circuit 210 may also comprise a delay element 205 that is configured to delay the trigger signal S by a predetermined amount of time. The ADC 203 is configured to receive the trigger signal S and to only sample the data signal V_{BUS} when the trigger signal S has the first value indicating a rising edge during the time window. The sampled value of the digitized data signal d_{BUS} is then stored in the register 201 and used for adapting the voltage source Q₁. The ADC 203 thus works in asynchronous operation, thereby saving energy. The register 201 may also be configured by a user or an external controller, which can be useful to set an initial reference voltage V_{REF}.

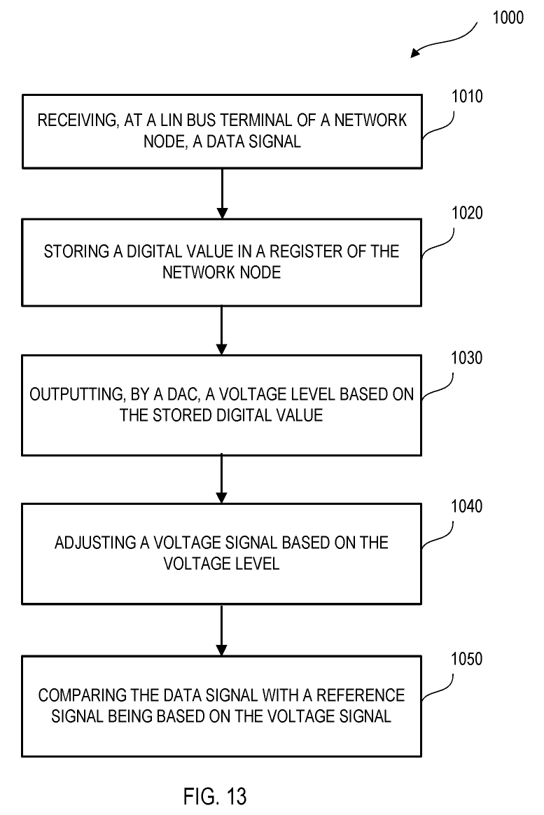

FIG. 13 is a flowchart illustrating an example method 1000 for adapting a voltage signal of a network node of a LIN bus system to a voltage signal of a further network node of the LIN bus system, in particular when a supply voltage of the network node is different from a further supply voltage of the further network node.

The example process 1000 can be employed to operate devices illustrated in this disclosure, such as the system according to FIG. 7 or the system according to FIG. 9.

Process 1000 comprises the step 1010 of receiving, at a Local Interconnect Network, LIN, bus terminal BUS₁ of a network node 1’’ of a LIN bus system, a data signal V_{BUS} representing serial data via a data line L_{DAT}. The data signal V_{BUS} is a binary signal having high and low signal level. The high signal level corresponds approximately to a further voltage signal V_{Q2} of a further voltage source Q₂ of the further network node, while the low signal level corresponds approximately to the ground level.

The process 1000 further comprises the step 1020 of storing at least one digital value d_{STORE} in a register 201 of the network node 1’’. In one example, the register 201 is configurable and the digital value d_{STORE} is input by a user, e.g. via a CAN line, or by an external controller, e.g. via an SPI. The digital value d_{STORE} may be chosen to correspond to the expected high signal level of the data signal V_{BUS}. With this, a voltage signal V_{Q1} of a voltage source Q₁ of the network node can be adjusted to the high signal level in a simple manner. In one example, which may be combine with the previous example, the process further comprises the steps of digitizing, by an analog digital converter, ADC, 203, the data signal V_{BUS} to generate a digitized data signal d_{BUS}, and storing, in the register 201, a digital value d_{STORE} of the digitized data signal d_{BUS} that represents a high signal level of the data signal V_{BUS}. With this, the voltage signal V_{Q1} can be dynamically adjusted directly based on the data signal V_{BUS}. The adjustment of the voltage signal V_{Q1} can thus be particularly accurate.

The process 1000 also comprises the step 1030 of outputting, by a digital-to-analog converter, DAC, 202 a voltage level V_{STORE} based on the stored digital value d_{STORE}.

In addition, the process 1000 comprises the step 1040 of adjusting a voltage signal V_{Q1} output by a voltage source Q₁ coupled to a supply terminal VS₁ of the network node 1’’ based on the voltage level V_{STORE}. The voltage source Q₁ is controllable and connected to a supply terminal VS₁ which is supplied with a supply voltage V_{S1}. However, the supply voltage V_{S1} may differ from a supply voltage V_{S2} provided to a supply terminal VS₂ of a further network node 1 (LIN commander) that sends the data signal V_{BUS}. Because of this, the network node 1’’ may not be able to accurately reproduce the data signal V_{BUS}, thus leading to a loss of communication between the network nodes. By adjusting the voltage source Q₁, it is possible to improve the processing of the data signal V_{BUS} and, thus, to prevent losses of communication. In one example, the voltage source Q₁ is a charge pump. This makes it possible to scale the supply voltage V_{S1} up or down depending on the voltage level V_{STORE}, irrespective of whether the supply voltage V_{S1} is higher or lower than the further supply voltage V_{S2} of he further network node 1.

The process 1000 further comprises the step 1050 of comparing the data signal V_{BUS} with a reference signal V_{REF} to generate a binary output signal V_{RX} representing the result of the comparison, wherein the reference signal V_{REF} is based on the voltage signal V_{Q1}. Since the voltage signal V_{Q1} has been adapted, according to the stored digital value d_{STORE}, the binary output signal V_{RX} is able to accurately follow the variations of the data signal V_{BUS}. In particular, the reference signal V_{REF} may be adapted to be equal to the reference signal of the further network node.

In one example, the process comprises the steps of outputting a trigger signal S based on the binary output signal V_{RX}, wherein the trigger signal S is a binary signal that indicates whether a rising edge of the data signal V_{BUS} has been detected, and storing, in the register 201, a current value d_{STORE} of the digitized data signal d_{BUS} based on the detector trigger signal S. The trigger signal S may be output with a first value when a rising edge has been detected. The register 201 may store the current value d_{STORE} when the trigger signal S has the first value. In one example, the process comprises the step of comparing the digitized data signal d_{BUS} to a digital threshold value d_{threshold} to generate a comparator output signal d_{binary} to detect a rising edge of the data signal V_{BUS}. The digital threshold value d_{threshold} may be configured. With this, rising edges of the data signal can be detected in a simple and accurate manner. In another example, the rising edge is detected based on the binary output signal V_{RX}.

In one example, the process also comprises the step of locking the register 201 until a further rising edge of the data signal V_{BUS} is detected. This makes it possible to reduce the number of adaptations of the voltage signal V_{Q1}.

In one example, a first window of the data signal V_{BUS} is detected. The step of outputting the trigger signal S is further based on the detected first window. The first window may be a sync field of a current frame of the data signal V_{BUS}, a check sum field of the current frame of the data signal V_{BUS}, or a space between two consecutive frames of the data signal V_{BUS}. During these time windows, the bus does not contain any useful information. By adapting the voltage signal V_{Q1}, during these time windows, the communication of useful information is not unnecessarily disturbed.

In one example, an end of the first window is detected, and the register 201 is locked after the detection of the end of the first window until a further window of the data signal V_{BUS} is detected. With this, the number of adaptations of the voltage signal V_{Q1} can be further reduced. In addition, interferences with the data signal V_{BUS}, in particular with the active fields of the data signal, can be avoided.

In one example, the trigger signal S is delayed, and a current value d_{STORE} of the digitized data signal d_{BUS} is stored in the register 201 based on the delayed trigger signal. With this, it can be ensured that the stored data value d_{STORE} corresponds to a high level value of the data signal V_{BUS}, and not to a value taken during a transition from a low level to a high level. This can further increase the accuracy of the receiver signal at the receiver terminal RX₁.

In one example, the data signal V_{BUS} is sampled continuously at a predetermined frequency. In another example, the data signal V_{BUS} is sampled based on the trigger signal S. With this, the energy consumption of the responder node 1’’ can be reduced.

The present application describes a network node of a LIN system, such as a LIN responder. In conventional systems, the master device and the slave devices of the LIN system share a common voltage domain that is used as a reference for the receivers of the network nodes and that is typically the standard LIN-compatible 12 V voltage domain. However, new automotive board nets may have higher voltages, e.g. 24V, 48V, 400 V or 800 V. The master device and the slave devices of the LIN system may thus have different supply voltages and, thus, different reference voltages for the respective receivers. If the supply voltages are different, the slave node may thus not be able to accurately identify the recessive and the dominant states of the LIN data signal, thus leading to losses of communication. This problem is solved by using a controllable voltage source coupled to the supply terminal and a controller circuit that is configured to adjust a voltage signal of the controllable voltage source based on a voltage level. The voltage level is based on a digital value stored in a register. The controller circuit is digital and comprises a digital-to-analog converter for outputting the voltage level based on the stored digital value. The controller circuit may adjust the controllable voltage source during recessive states of the LIN data signal. The processing of the data signal in the slave node is based on the adjusted voltage signal. With this, the processing of the data signal may be more accurate and the robustness of the LIN network may be increased. In particular, the threshold values of the comparator used for generating the receiver signal can be adapted to the high level voltage of the data signal.

The digital value in the register may be configured in a simple manner by a user or by an external controller. Alternatively, the controller circuit may comprise an analog-to-digital converter configured to digitize the data signal and the register may be configured to store values of the digitized data signal. With this, the recessive level of the data signal can be directly measured. This enables a dynamic control of the voltage signal of the controllable voltage source, so that the network node can adapt to variations of the high level signal and of the supply voltages. The controller circuit may be configured to detect rising edges of the data signal, so that the register can store values of the digitized data signal that correspond to the high level signal. The controller circuit may also be configured to detect time windows of the data signal. This makes it possible to only adapt the source voltage when the bus is not busy, thereby preventing interferences with the communication. The controller circuit may also delay the adaptation of the source voltage to make sure that the source voltage is adapted based on the high signal level of the data signal. The techniques described in the application thus make it possible to improve the communication between network nodes of a LIN system.

Although various embodiments have been illustrated and described with respect to one or more specific implementations, alterations and/or modifications may be made to the illustrated examples without departing from the spirit and scope of the features and structures recited herein. With particular regard to the various functions performed by the above described components or structures (units, assemblies, devices, circuits, systems, etc.), the terms (including a reference to a “means”) used to describe such components are intended to correspond – unless otherwise indicated – to any component or structure that performs the specified function of the described component (e.g., that is functionally equivalent), even if it is not structurally equivalent to the disclosed structure that performs the function in the herein illustrated exemplary implementations of the present disclosure. Furthermore, the methods of the application may be achieved in either all software implementations using the appropriate processor instructions or in hybrid implementations that utilize a combination of hardware logic and software logic to achieve the same results.

Although the present disclosure is not so limited, the following numbered examples demonstrate one or more aspects of the disclosure.

Example 1. A network node (1’’) of a LIN bus system comprising: a supply terminal (VS₁) configured to receive a supply voltage; a bus terminal (BUS₁) configured to receive a data signal (V_{BUS}) representing serial data via a data line (L_{DAT}), the data signal (V_{BUS}) being a binary signal having high and low signal levels; a controllable voltage source (Q₁) coupled to the supply terminal (VS₁), the voltage source (Q₁) being configured to output a voltage signal (V_{Q1}); a receiver circuit including a comparator (K₁) that is configured to compare the data signal (V_{BUS}) with a reference signal (V_{REF}), wherein the comparator (K₁) generates a binary output signal (V_{RX}) representing the result of the comparison, wherein the reference signal (V_{REF}) is based on the voltage signal (V_{Q1}); and a controller circuit (200) comprising: a register (201) that is configured to store at least one digital value (d_{STORE}), and a digital-to-analog converter, DAC, (202) that is coupled to the register (201) and configured to output a voltage level (V_{STORE}) based on the stored digital value (d_{STORE}), wherein the controller circuit (200) is coupled to the voltage source (Q₁) and configured to adjust the voltage signal (V_{Q1}) based on the voltage level (V_{STORE}).

Example 2. The network node of example 1, wherein the register (201) is configurable by one of: an external controller; and a user.

Example 3. The network node of example 1 or 2, wherein the controller circuit (200) is coupled to the bus terminal (BUS₁) and further comprises an analog-to-digital converter, ADC, (203) configured to receive the data signal (V_{BUS}) and to generate a digitized data signal (d_{BUS}) based on the data signal (V_{BUS}), wherein the register (201) is coupled to the ADC (203) and is further configured to: receive the digitized data signal (d_{BUS}) from the ADC (203), and store a value (d_{STORE}) of the digitized data signal (d_{BUS}) that represents a high signal level of the data signal (V_{BUS}).

Example 4. The network node of example 3, wherein the controller circuit (200) further comprises a detector circuit (210) that is configured to receive the binary output signal (V_{RX}); and output a trigger signal (S), wherein the trigger signal (S) is a binary signal that indicates whether a rising edge of the data signal (V_{BUS}) has been detected, and wherein the register (201) is further configured to store the value (d_{STORE}) of the digitized data signal (d_{BUS}) based on the trigger signal (S).

Example 5. The network node of example 4, wherein the detector circuit (210) comprises a digital comparator (K_{d}) that is configured to compare the digitized data signal (d_{BUS}) with a digital threshold value (d_{threshold}) to detect the rising edge of the data signal (V_{BUS}).

Example 6. The network node of example 4 or 5, wherein the stored current value (d_{STORE}) remains unchanged until a further rising edge of the data signal (V_{BUS}) has been detected.

Example 7. The network node of any one of examples 4 to 6, wherein the detector circuit (210) further comprises a frame decoder (204) configured to determine a first time window of the data signal (V_{BUS}), and the detector circuit (210) is configured to output the trigger signal (S) further based on the determined first time window.

Example 8. The network node of example 7, wherein the first time window is one of: a sync field of a current frame of the data signal (V_{BUS}); a check sum field of the current frame of the data signal (V_{BUS}); and a space between two consecutive frames of the data signal (V_{BUS}).

Example 9. The network node of example 7 or 8, wherein the frame decoder (204) is further configured to detect an end of the first time window of the data signal (V_{BUS}), and wherein the register (201) is configured to be locked after the detection of the end of the first time window until the frame decoder (204) detects a further time window of the data signal (V_{BUS}).

Example 10. The network node of any one of examples 4 to 9, wherein the detector circuit (210) further comprises a delay element (205) configured to delay the trigger signal (S) by a predetermined delay time (t_{delay}).

Example 11. The network node of example 10, when it depends on example 5, wherein the delay element (205) is coupled to the output of the digital comparator (K_{d}) and configured to delay a comparator output signal (d_{binary}) by the predetermined delay time (t_{delay}).

Example 12. The network node of example 10 or 11, wherein the predetermined delay time (t_{delay}) is configurable.

Example 13. The network node of any one of examples 10 to 12, wherein the register (201) is coupled to an output of the delay element (205) and is configured to store a current value (d_{STORE}) of the digitized data signal (d_{BUS}) based on the delayed trigger signal.

Example 14. The network node of any one of examples 1 to 13, wherein the voltage source (Q₁) is a charge pump.

Example 15. The network node of any one of examples 1 to 14, further comprising: a pull-up resistor (R₁) connected between the LIN bus terminal (BUS₁) and an output of voltage source (Q₁), wherein pull-up resistor (R₁) is configured to be switched on and off based on the trigger signal (S).

Example 16. A LIN bus system (100), comprising: a network node (1’’) according to any one of examples 1 to 15; and a further network node (1), wherein the second network node comprises: a further supply terminal (VS₂) configured to receive a further supply voltage (V_{S2}); a further bus terminal (BUS₂) configured to send the data signal (V_{BUS}); a further voltage source (Q₂) coupled to the further supply terminal (VS₂), the further voltage source (Q₂) being configured to output a further voltage signal (V_{Q2}); and a further receiver circuit including a further comparator (K₂) that is configured to compare the data signal (V_{BUS}) with a further reference signal, wherein the further comparator (K₂) generates a further binary output signal representing the result of the comparison, wherein the further reference signal is based on the further voltage signal (V_{Q2}); wherein the supply voltage (V_{S1}) is different from the further supply voltage (V_{S2}).

Example 17. A method, comprising: receiving, at a Local Interconnect Network, LIN, bus terminal (BUS₁) of a network node (1’’) of a LIN bus system, a data signal (V_{BUS}) representing serial data via a data line (L_{DAT}), the data signal (V_{BUS}) being a binary signal having high and low signal levels; storing at least one digital value (d_{STORE}) in a register (201) of the network node (1’’); outputting, by a digital-to-analog converter, DAC, (202) a voltage level (V_{STORE}) based on the stored digital value (d_{STORE}); adjusting a voltage signal (V_{Q1}) output by a voltage source (Q₁) coupled to a supply terminal (VS₁) of the network node (100) based on the voltage level (V_{STORE}); comparing the data signal (V_{BUS}) with a reference signal (V_{REF}) to generate a binary output signal (V_{RX}) representing the result of the comparison, wherein the reference signal (V_{REF}) is based on the voltage signal (V_{Q1}).

Example 18. The method of example 17, further comprising: digitizing, by an analog digital converter, ADC, (203), the data signal (V_{BUS}) to generate a digitized data signal (d_{BUS}), and storing, in the register (201), a digital value (d_{STORE}) of the digitized data signal (d_{BUS}) that represents a high signal level of the data signal (V_{BUS}).

Example 19. The network node of example 17 or 18, further comprising: outputting a trigger signal (S) based on the binary output signal (V_{RX}), wherein the trigger signal (S) is a binary signal that indicates whether a rising edge of the data signal (V_{BUS}) has been detected; and storing, in the register (201), a current value (d_{STORE}) of the digitized data signal (d_{BUS}) based on the trigger signal (S).

Example 20. The method of example 19, further comprising comparing the digitized data signal (d_{BUS}) with a digital threshold value (d_{threshold}) to detect the rising edge of the data signal (V_{BUS}).

Example 21. The method of example 19 or 20, further comprising: locking the register (201) until a further rising edge of the data signal (V_{BUS}) has been detected.

Example 22. The method of any one of examples 19 to 21, further comprising: detecting a first time window of the data signal (V_{BUS}), wherein the step of outputting the trigger signal (S) is further based on the detected first time window.

Example 23. The method of example 22, further comprising: detecting an end of the first time window, and locking the register (201) after the detection of the end of the first time window until a further time window of the data signal (V_{BUS}) is detected.

Example 24. The method of any one of examples 19 to 23, further comprising: delaying the trigger signal (S); and storing, in the register (201), a current value (d_{STORE}) of the digitized data signal (d_{BUS}) based on the delayed trigger signal.

1. A network node of a LIN bus system comprising:
a supply terminal (VS₁) configured to receive a supply voltage;
a bus terminal (BUS₁) configured to receive a data signal (V_{BUS}) representing serial data via a data line (L_{DAT}), the data signal (V_{BUS}) being a binary signal having high and low signal levels;
a controllable voltage source (Q₁) coupled to the supply terminal (VS₁), the voltage source (Q₁) being configured to output a voltage signal (V_{Q1});
a receiver circuit including a comparator (K₁) that is configured to compare the data signal (V_{BUS}) with a reference signal (V_{REF}), wherein the comparator (K₁) generates a binary output signal (V_{RX}) representing the result of the comparison, wherein the reference signal (V_{REF}) is based on the voltage signal (V_{Q1}); and
a controller circuit comprising:
a register that is configured to store at least one digital value (d_{STORE}), and
a digital-to-analog converter, DAC, that is coupled to the register and configured to output a voltage level (V_{STORE}) based on the stored digital value (d_{STORE}),
wherein the controller circuit is coupled to the voltage source (Q₁) and configured to adjust the voltage signal (V_{Q1}) based on the voltage level (V_{STORE}1).

2. The network node of claim 1,
wherein the register is configurable by one of: an external controller; and a user.

3. The network node of claim 1,
wherein the controller circuit is coupled to the bus terminal (BUS₁) and further comprises an analog-to-digital converter, ADC, configured to receive the data signal (V_{BUS}) and to generate a digitized data signal (d_{BUS}) based on the data signal (V_{BUS}),
wherein the register is coupled to the ADC and is further configured to:
receive the digitized data signal (d_{BUS}) from the ADC, and
store a value (d_{STORE}) of the digitized data signal (d_{BUS}) that represents a high signal level of the data signal (V_{BUS}3).

4. The network node of claim 3,
wherein the controller circuit further comprises a detector circuit that is configured to:
receive the binary output signal (V_{RX}); and
output a trigger signal (S), wherein the trigger signal (S) is a binary signal that indicates whether a rising edge of the data signal (V_{BUS}) has been detected, and
wherein the register is further configured to store the value (d_{STORE}) of the digitized data signal (d_{BUS}) based on the trigger signal (S).

5. The network node of claim 4,
wherein the detector circuit comprises a digital comparator (K_{d}) that is configured to compare the digitized data signal (d_{BUS}) with a digital threshold value (d_{threshold}) to detect the rising edge of the data signal (V_{BUS}5).

6. The network node of claim 5,
wherein the stored current value (d_{STORE}) remains unchanged until a further rising edge of the data signal (V_{BUS}) has been detected.

7. The network node of claim 6,
wherein the detector circuit further comprises a frame decoder configured to determine a first time window of the data signal (V_{BUS}), and
the detector circuit is configured to output the trigger signal (S) further based on the determined first time window.

8. The network node of claim 7,
wherein the first time window is one of: a sync field of a current frame of the data signal (V_{BUS}); a check sum field of the current frame of the data signal (V_{BUS}); and a space between two consecutive frames of the data signal (V_{BUS}8).

9. The network node of claim 7,
wherein the frame decoder is further configured to detect an end of the first time window, and
wherein the register is configured to be locked after the detection of the end of the first time window until the frame decoder detects a further time window of the data signal (V_{BUS}9).

10. The network node of claim 4,
wherein the detector circuit further comprises a delay element configured to delay the trigger signal (S) by a predetermined delay time (t_{delay}10).

11. The network node of claim 10,
wherein the delay element is coupled to the output of a digital comparator (K_{d}) and configured to delay a comparator output signal (d_{binary}) by the predetermined delay time (t_{delay}11).

12. The network node of claim 10,
wherein the predetermined delay time (t_{delay}) is configurable.

13. The network node of claim 10,
wherein the register is coupled to an output of the delay element and is configured to store a current value (d_{STORE}) of the digitized data signal (d_{BUS}) based on the delayed trigger signal.

14. The network node of claim 1,
wherein the voltage source (Q₁) is a charge pump.

15. The network node of claim 1, further comprising:
a pull-up resistor (R₁) connected between the LIN bus terminal (BUS₁) and an output of voltage source (Q₁),
wherein the pull-up resistor (R₁) is configured to be switched on and off based on the trigger signal (S).

16. The network node of claim 1, wherein network node is a first network node of the LIN bus system and further comprising:
a second network node, wherein the second network node comprises:
a further supply terminal (VS₂) configured to receive a further supply voltage (V_{S2});
a further bus terminal (BUS₂) configured to send the data signal (V_{BUS});
a further voltage source (Q₂) coupled to the further supply terminal (VS₂), the further voltage source (Q₂) being configured to output a further voltage signal (V_{Q2}); and
a further receiver circuit including a further comparator (K₂) that is configured to compare the data signal (V_{BUS}) with a further reference signal, wherein the further comparator (K₂) generates a further binary output signal representing the result of the comparison, wherein the further reference signal is based on the further voltage signal (V_{Q2});
wherein the supply voltage (V_{S1}) is different from the further supply voltage (V_{S2}16).

17. A method, comprising:
receiving, at a Local Interconnect Network, LIN, bus terminal (BUS₁) of a network node (1’’) of a LIN bus system, a data signal (V_{BUS}) representing serial data via a data line (L_{DAT}), the data signal (V_{BUS}) being a binary signal having high and low signal levels;
storing at least one digital value (d_{STORE}) in a register of the network node;
outputting, by a digital-to-analog converter, DAC, a voltage level (V_{STORE}) based on the stored digital value (d_{STORE});
adjusting a voltage signal (V_{Q1}) output by a voltage source (Q₁) coupled to a supply terminal (VS₁) of the network node based on the voltage level (V_{STORE});
comparing the data signal (V_{BUS}) with a reference signal (V_{REF}) to generate a binary output signal (V_{RX}) representing the result of the comparison, wherein the reference signal (V_{REF}) is based on the voltage signal (V_{Q1}17).

18. The method of claim 17, further comprising:
digitizing, by an analog digital converter, ADC, the data signal (V_{BUS}) to generate a digitized data signal (d_{BUS}); and
storing, in the register, a digital value (d_{STORE}) of the digitized data signal (d_{BUS}) that represents a high signal level of the data signal (V_{BUS}18).

19. The method of claim 17, further comprising:
outputting a trigger signal (S) based on the binary output signal (V_{RX}), wherein the trigger signal (S) is a binary signal that indicates whether a rising edge of the data signal (V_{BUS}) has been detected; and
storing, in the register, a current value (d_{STORE}) of the digitized data signal (d_{BUS}) based on the trigger signal (S).

20. The method of claim 19, further comprising:
detecting a first time window of the data signal (V_{BUS}),
wherein the step of outputting the trigger signal (S) is further based on the detected first time window.
